(19) United States
(12) Patent Application Publication
(10) Pub. No.: US 2023/0171218 A1
(43) Pub. Date: Jun. 1, 2023

(54) METHOD AND DEVICE FOR DISPLAYING MESSAGE, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Tiantian Wang, Beijing (CN); Along Yao, Beijing (CN); Boyang Yu, Beijing (CN); Chenyang Li, Beijing (CN); Xuangang Feng, Beijing (CN); Bolin Zhang, Beijing (CN); Min Zhang, Beijing (CN)

(21) Appl. No.: 17/875,738

(22) Filed: Jul. 28, 2022

(30) Foreign Application Priority Data
Nov. 30, 2021 (CN) 202111444399.9

(51) Int. Cl. H04L 51/224; H04L 51/10; H04L 51/216; G06F 3/04812; H04L 51/066

(52) U.S. Cl. CPC H04L 51/224; G06F 3/04812; H04L 51/10; H04L 51/066; H04L 51/216

(57) ABSTRACT

The disclosure provides a method for displaying a message. The method includes in response to receiving an emoji-expressive reply operation performed by a first user account on a conversation message sent by a second user account, obtaining a system message corresponding to the emoji-expressive reply operation. The system message includes a user identification of the first user account, an abbreviated message identification, and attitude information corresponding to the emoji-expressive reply operation. The method further includes displaying the system message on a chat interface of a chat conversation including the second user account.

### CROSS REFERENCE TO RELATED APPLICATIONS

This application claims priority and benefits to Chinese Application No. 202111444399.9, filed on Nov. 30, 2021, the entire content of which is incorporated herein by reference.

### TECHNICAL FIELD

The disclosure relates to a field of Internet technologies, and in particular to a method and an apparatus for displaying a message, a related device, and a related storage medium

### BACKGROUND

Emoji-expressive reply refers to a reply provided by a user to a message on a chat dialog interface in the form of emoji in some social products.

### SUMMARY

According to a first aspect, there is provided a method for displaying a message. The method includes in response to receiving an emoji-expression reply operation performed by a first user account on a conversation message sent by a second user account, obtaining a system message corresponding to the emoji-expression reply operation, in which the system message includes a user identification of the first user account, an abbreviated message identification, and attitude information corresponding to the emoji-expressive reply operation, and displaying the system message on a chat interface of a chat conversation including the second user account.

According to a second aspect, there is provided an electronic device. The electronic device includes a processor, and a memory, storing instructions executable by the processor, in which the processor is configured to run the instructions to implement the method for displaying a message. The method includes in response to receiving an emoji-expression reply operation performed by a first user account on a conversation message sent by a second user account, obtaining a system message corresponding to the emoji-expression reply operation, in which the system message includes a user identification of the first user account, an abbreviated message identification, and attitude information corresponding to the emoji-expressive reply operation, and displaying the system message on a chat interface of a chat conversation including the second user account.

According to a third aspect of embodiments of the disclosure, there is provided a non-transitory computer readable storage medium. When instructions stored in the computer readable storage medium are executed by a processor of an electronic device, the electronic device is caused to implement the method for displaying a message. The method includes in response to receiving an emoji-expression reply operation performed by a first user account on a conversation message sent by a second user account, obtaining a system message corresponding to the emoji-expression reply operation, in which the system message includes a user identification of the first user account, an abbreviated message identification, and attitude information corresponding to the emoji-expressive reply operation, and displaying the system message on a chat interface of a chat conversation including the second user account.

It is to be understood that the foregoing general description and the following detailed description are exemplary and explanatory only and are not restrictive of the disclosure.

### BRIEF DESCRIPTION OF THE DRAWINGS

The accompanying drawings, which are incorporated into and constitute a part of this specification, illustrate embodiments consistent with the disclosure, serve to explain the principles of the disclosure together with the description, and do not form undue limitation of the disclosure.

FIG. 1 is a schematic diagram illustrating an implementation environment of a method for displaying a message according to an embodiment.

FIG. 2 is a flowchart illustrating a method for displaying a message according to an embodiment.

FIG. 3A is a schematic diagram illustrating an interface of a processing process of a message of a group conversation according to an embodiment.

FIG. 3B is a schematic diagram illustrating an interface of a processing process of a message of a personal conversation according to an embodiment.

FIG. 4A is a schematic diagram illustrating an interface that a system message is displayed at the bottom of a visible region of a chat interface according to an embodiment.

FIG. 4B is a schematic diagram illustrating an interface that a system message is displayed at the top of a visible region of a chat interface according to an embodiment.

FIG. 5A is a schematic diagram illustrating an interface of a process of displaying user profile information according to an embodiment.

FIG. 5B is a schematic diagram illustrating an interface of a process of displaying user profile information according to an embodiment.

FIG. 6A is a schematic diagram illustrating an interface of a viewing process on an abbreviated message identification according to an embodiment.

FIG. 6B is a schematic diagram illustrating an interface of a viewing process performed on an abbreviated message identification according to an embodiment.

FIG. 7 is a schematic diagram illustrating an interface of a process of abbreviating a system message according to an embodiment.

FIG. 8 is a schematic diagram illustrating an interface of a process of abbreviating a system message according to an embodiment.

FIG. 9A is a schematic diagram illustrating an interface of performing emoji-expressive reply operations by different first user accounts on a conversation message according to an embodiment.

FIG. 9B is a schematic diagram illustrating an interface of performing emoji-expressive reply operations by different third user accounts on a conversation message according to an embodiment.

FIG. 9C is a schematic diagram illustrating an interface of continuously performing emoji-expressive reply operations on the same conversation message by the same user account according to an embodiment.

FIG. 9D is a schematic diagram illustrating a specific interface of a processing process of a conversation message according to an embodiment.

FIG. 10 is a schematic diagram illustrating an apparatus for displaying a message according to an embodiment.

FIG. 11 is a block diagram illustrating an electronic device according to an embodiment.

### DETAILED DESCRIPTION

In order to make those skilled in the art well understand the technical solutions of the disclosure, the technical solutions in the embodiments of the disclosure will be clearly and completely described below with reference to the accompanying drawings.

It is to be noted that the terms “first”, “second” and the like in the description and claims of the disclosure and the above drawings are used to distinguish similar objects, and are not necessarily used to describe a specific sequence or order. It is understandable that the data defined by these terms are interchangeable under appropriate circumstances such that the embodiments of the disclosure described herein can be practiced in sequences other than those illustrated or described herein. The implementations described in the illustrative examples below are not intended to represent all implementations consistent with this disclosure. Rather, they are merely examples of apparatus and methods consistent with some aspects of the disclosure as recited in the appended claims.

In practical applications, in some products, an emoji-expressive reply is provided to the user through notification by means of the pop-up window on the terminal. The notification is conspicuous, such that too many emoji-expressive replies will cause interference to the user. In some products, the emoji-expressive reply is not provided to the user through the notification by means of the pop-up window, but is provided to the user by displaying “attitude and message content” in the message list of the conversation. That is, the attitude and the specific content of the target message to be replied are displayed together, which causes that the content to be viewed by users is mixed and disorderly and increases the difficulty of understanding.

In view of this, the disclosure provides a method for displaying a message. In response to receiving an emoji-expressive reply operation performed by a first user account on a conversation message sent by a second user account, a system message corresponding to the emoji-expressive reply operation is received. Since the system message includes a user identification of the first user account and attitude information corresponding to the emoji-expressive reply operation, the second user account can quickly know who has performed the emoji-expressive reply operation on the conversation message sent by the second user account, and at the same time understand the attitude information corresponding to the emoji-expressive reply operation. Due to the abbreviated message identification, there is no need to display the specific content of the message, such that the system message is concise and clear, and the difficulty of understanding is reduced. In addition, the disclosure displays the system message on the chat interface of the chat conversation including the second user account and does not notify the user in other forms, and the user can clearly see the system message when opening the chat interface. Therefore, the interference to the user is reduced.

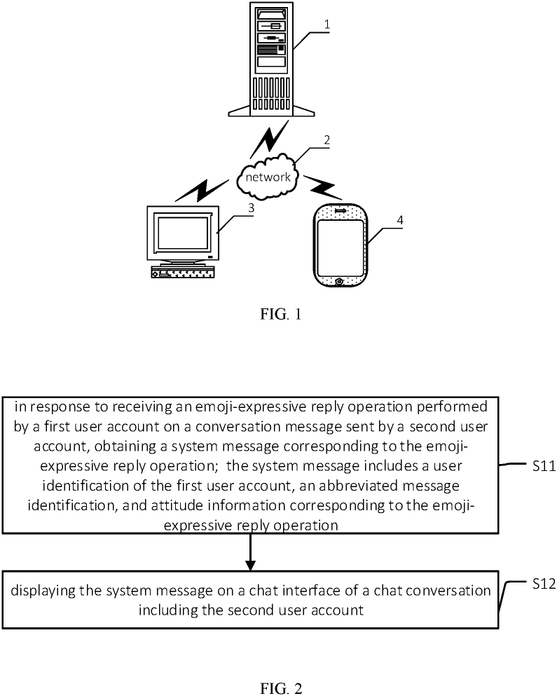

FIG. 1 is a schematic diagram illustrating an implementation environment of a method for displaying a message according to an embodiment. As illustrated in FIG. 1, the implementation environment may include a server 1, a network 2, and multiple terminal devices, such as a terminal device 3, a terminal device 4, etc.

The server 1 may be a physical server including an independent host, or may be a virtual server carried by a host cluster, or may be a cloud server. The server 1 may run server-side codes of a certain instant messaging application to implement related functions.

The terminal device 3 and the terminal device 4 respectively correspond to different users. For example, in the case of establishing a certain group through an instant messaging application, the users corresponding to the terminal device 3 and the terminal device 4 may be two users in the group, i.e., the first user account and the second user account. A conversation message sent by the first user account in the group through the terminal device 3 can be received and displayed by the second user account through the terminal device 4.

In practical applications, the terminal device may be a mobile phone, a personal computer (PC for short), a tablet computer, a notebook computer, a wearable device, and the like. The client-side codes of a certain instant messaging application can be run in the terminal device to implement related functions.

The network 2 used to support the communication between a plurality of terminal devices and the server 1 may include various types of wired or wireless networks. Different terminal devices such as terminal device 3 and terminal device 4 can also communicate through the network 2, for example, a one-to-one communication conversation is established between terminal device 3 and terminal device 4, or multiple terminal devices can participate in the same group conversation such that any user in the group can send conversation messages to all other users in the group through its own terminal device.

The method for displaying a message provided herein will be described in detail below with reference to the following embodiments.

FIG. 2 is a flowchart illustrating a method for displaying a message according to an embodiment. The method for displaying a message may be executed by a terminal device such as the terminal device 3 or the terminal device 4 in FIG. 1. As illustrated in FIG. 2, the method includes the following.

In block S11, in response to receiving an emoji-expressive reply operation performed by a first user account on a conversation message sent by the second user account, a system message corresponding to the emoji-expressive reply operation is obtained. The system message includes a user identification of the first user account, an abbreviated message identification, and attitude information corresponding to the emoji-expressive reply operation.

In block S12, the system message is displayed on a chat interface of a chat conversation including the second user account.

In embodiments of the disclosure, the chat interface of the chat conversation including the second user account may be a personal chat interface established between the first user account and the second user account, or may be a group chat interface of a group including both the first user account and the second user account.

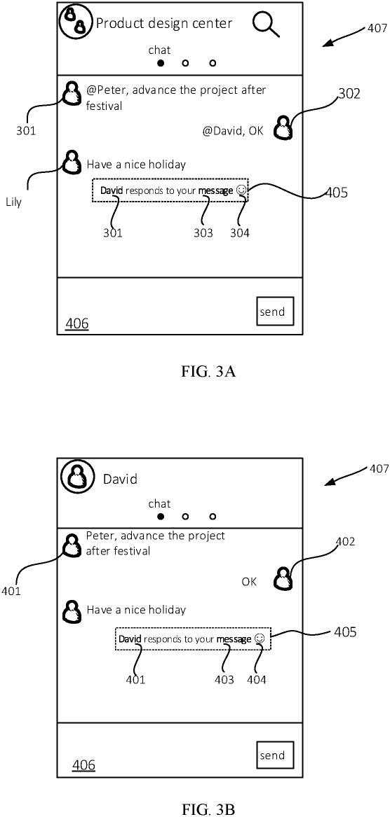

For ease of understanding, in conjunction with FIG. 3A and FIG. 3B, the process in which the first user account performs the emoji-expressive reply operation on the conversation message sent by the second user account in the above two scenarios is described.

FIG. 3A is a schematic diagram illustrating an interface of a processing process of a message of a group conversation according to an embodiment. In FIG. 3A, the group name is “Product Design Center”, the first user account and the second user account are both in this group. The chat interface illustrated as FIG. 3A is from the perspective of the second user account. For example, the first user account is David 301, and the second user account is Peter 302. After Peter 302 replied “OK” to David 301, David 301 performs an emoji-expressive reply operation on “OK”, a system message is generated on the group chat interface, and the system message is “David responds to your message (smiley face emoji)”, which can be seen from FIG. 3A for details. “David” 301 is the user identification of the first user account in the system message, and “message” 303 is the abbreviated message identification in the system message, and the smiley face emoji 304 is the attitude information corresponding to the emoji-expressive reply operation in the system message.

FIG. 3B is a schematic diagram illustrating an interface of a processing process of a message of a personal conversation according to an embodiment. FIG. 3B shows a chat interface of the chat conversation between the first user account and the second user account. FIG. 3B is from the perspective of the second user account. In FIG. 3B, the first user account is David 401, and the second user account is Peter 402, after Peter 402 replied “Ok” to David 401, David 401 performs an emoji-expressive reply operation on “Ok”, and a system message is generated on the personal chat interface between David 401 and Peter 402. The system message is “David responds to your message (smiley face emoji)”, which can be seen from FIG. 3B for details, where “David” 401 is the user identification of the first user account in the system message, and “message” 403 is the abbreviated message identification in the system message, and the smiley face emoji 404 is the attitude information corresponding to the emoji-expressive reply operation in the system message.

It is understandable that, in order to ensure that the system message to be viewed by the second user account is concise and clear, it can be set herein that: different conversation messages correspond to the same abbreviated message identification. That is, regardless of the specific content of the message sent by the first user account and the second user account, the abbreviated message identification in the system message is a word “message”.

It is to be noted that, for the emoji-expressive reply operation, if the user responds to a message sent by himself/herself, no system message is generated, but the attitude information is displayed under the message sent by himself/herself. Under normal circumstances, the attitude information is presented as emoji(s). However, once the emoji cannot be displayed normally due to version compatibility problems, device compatibility problems, etc., the attitude information can be displayed in the form of text. In an example, the emoji can be replaced with “[customized emoji]”.

Further, in order to make the system message to be viewed by the second user account to be conspicuous, there are two ways to display the system message on the chat interface of the chat conversation including the second user account below, which are not used to limit the disclosure. In detail, displaying the system message on the chat interface of the chat conversation including the second user account includes the following.

First way: The system message is displayed at the top or bottom of a visible region of the chat interface of the chat conversation including the second user account.

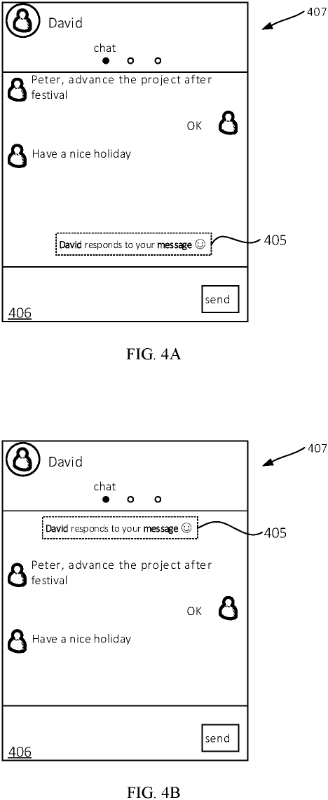

For ease of understanding, the position where the system message is displayed on the chat interface will be described in combination with FIG. 4A and FIG. 4B. FIG. 4A and FIG. 4B both illustrate the visible region of the chat interface. FIG. 4A is a schematic diagram illustrating an interface where the system message 405 is displayed at the bottom of the visible region of the chat interface, and FIG. 4B is a schematic diagram illustrating an interface where the system message 405 is displayed at the top of the visible region of the chat interface. The above-mentioned visible region is the newest visible region of the chat interface.

Second way: The system message is displayed within a preset region of the chat interface of the chat conversation including the second user account. The preset region is determined based on a position of a message input box and a position of a last conversation message on the chat interface.

For ease of understanding, this way will be described in combination with FIG. 3A and FIG. 3B. In FIG. 3A and FIG. 3B, the system message 405 is displayed between the message input box 406 and the last conversation message on the chat interface. In order to improve the visual effect, the system message 405 is displayed at the middle between the message input box 406 and the last conversation message. The position of message input box 406 refers to the position where the second user account inputs the conversation message to be sent.

Through the above two ways, the user can be prompted without additionally sending a notification to the user, the notifying effect is good, and the user will not be disturbed.

It is to be noted that, in embodiments of the disclosure, the time of displaying the system message is the time when the first user account performs the emoji-expressive reply operation on the conversation message sent by the second user account.

After the user opens the chat interface and sees the system message, the user generally wants to know personal information of the person who responds to the message. Based on this situation, in embodiments of the disclosure, after displaying the system message on the chat interface, the method also includes in response to a viewing operation performed by the second user account on the user identification, displaying profile information of the first user account.

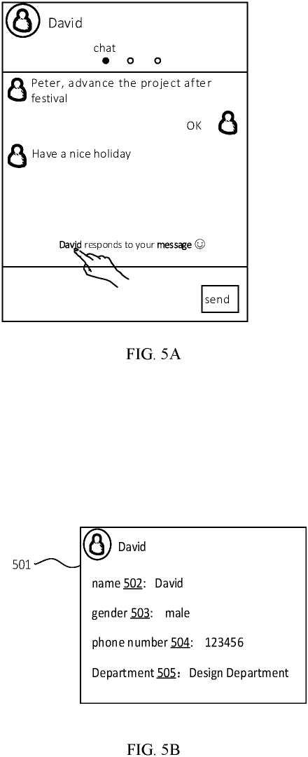

For ease of understanding, the viewing process triggered by performing the viewing operation on the user identification by the second user account will be described in combination with FIG. 5A and FIG. 5B below. In FIG. 5A, after the user clicks “David (i.e., the user identification of the first user account)”, the chat interface is illustrated as FIG. 5B, where the profile information 501 of “David” is displayed. The profile information 501 includes the name 502, the gender 503, the phone number 504, the department 505, and the like.

After the user opens the chat interface and sees the system message, the user will want to know which conversation message is responded to. Based on this situation, in embodiments of the disclosure, after displaying the system message on the chat interface, the method further includes: in response to a viewing operation performed by the second user account on the abbreviated message identification, jumping to a position of displaying the conversation message, and highlighting the conversation message.

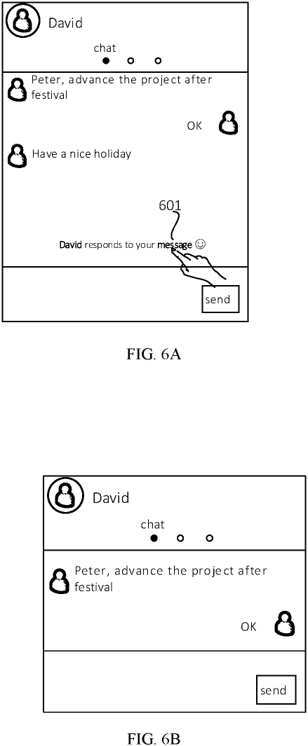

For ease of understanding, the viewing process triggered by performing the viewing operation on the abbreviated message identification will be described in combination of FIG. 6A and FIG. 6B. In FIG. 6A, after the user clicks “message” 601 (i.e., the abbreviated message identification of the second user account), the chat interface will jump to the position of displaying the conversation message (i.e., “OK”), as illustrated in FIG. 6B.

It is understandable that the user identification of the first user account and the abbreviated message identification are the viewing and access entrance of corresponding information. In order to make the user identification of the first user account and the abbreviation message identification to be more conspicuous than the second user account, and at the same time make it convenient for the user to perform the viewing and jump operation (which is for example a click operation), the user identification of the first user account and the abbreviated message identification can be highlighted, underlined or displayed in bold type on the chat interface.

In addition, the message that has been responded to may be deleted or withdrawn. For these two cases, embodiments of the disclosure provide corresponding processing methods, which will be described below.

When the conversation message that has been responded to is deleted, the system message corresponding to the emoji-expressive reply operation still exists. At this time, after the abbreviated message identification (i.e., the “message”) in the system message is clicked, a prompt will pop up to inform the user that the conversation message has been deleted.

When the conversation message that has been responded to is withdrawn, the system message corresponding to the emoji-expressive reply operation still exists. At this time, clicking the abbreviated message identification (i.e., the “message”) in the system message will cause the page jumps to the position where the conversation message was withdrawn.

In embodiments of the disclosure, there is a chat conversation list, and profile photos of target users who can chat with the second user account are displayed, and a part of chat content is briefly displayed in the chat conversation list. Ways of highlighting the system message on the chat interface of the second user account vary with states of displaying the chat interface. There are two ways of highlighting the system message on the chat interface of the second user account below, which are not used to limit the disclosure.

First way: If the chat interface is in an open state, the system message is displayed on the chat interface.

For ease of understanding, this way will be described below in combination with FIG. 3B. In FIG. 3B, the chat conversation between the first user account (David) 401 and the second user account (Peter) 402 is displayed on the chat interface 407. The chat interface 407 is in a displaying state, that is, David 401 is chatting with Peter 402. In this case, the system message is highlighted on the chat interface 407 of the second user account.

Second way: If the chat interface 407 is in a closed state, the system message is abbreviated. The abbreviated system message is displayed within a preview region of a target chat conversation corresponding to the first user account in the chat conversation list. The target chat conversation is a chat conversation between the first user account and the second user account. In response to a viewing operation performed by the second user account on the preview region of the target chat conversation, the chat interface is displayed and the system message that is not abbreviated is displayed on the chat interface.

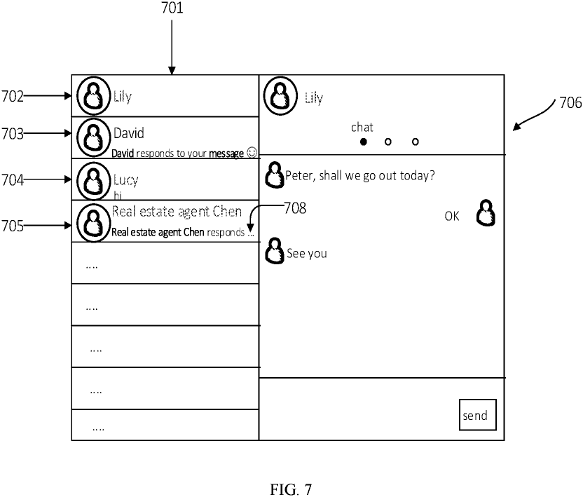

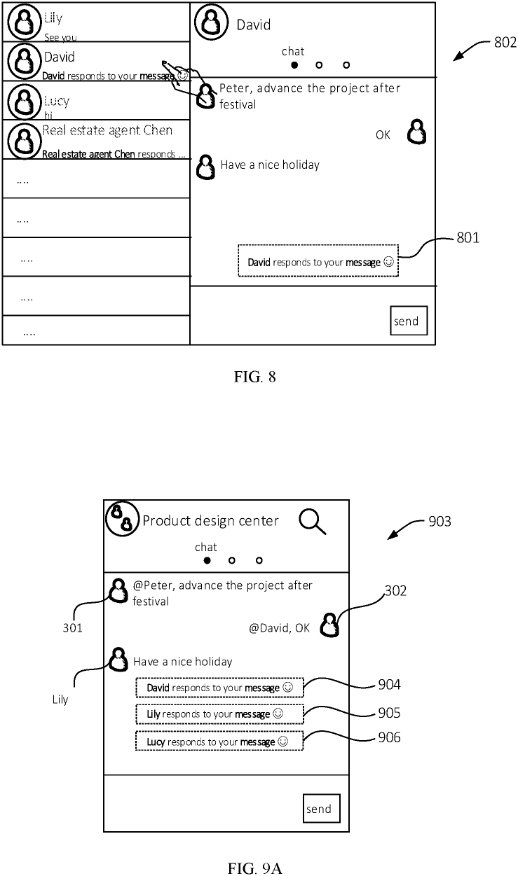

For ease of understanding, this way will be described below in combination with FIG. 7 and FIG. 8. In FIG. 7, the chat conversation list 701 includes preview regions 702, 703, 704, 705 of chat conversations of “Lily,” “David,” “Lucy,” “Real estate agent Chen” and so on. The chat conversation 702 between the second user account (Peter) and other user account (Lily) is displayed on the chat interface 706. At this time, the chat interface 706 is in the closed state for the first user account (David) who has performed the emoji-expressive reply operation. In other words, the chat conversation on the chat interface 706 illustrated as FIG. 7 is not between the first user account (David) and the second user account (Peter). In this case, the system message generated by David during the chat conversation is abbreviated and the abbreviated system message 707 is displayed within the preview region 702 of the chat conversation corresponding to David in the chat conversation list 701. Clicking “David” causes the page jumps to a page illustrated as FIG. 8, where FIG. 8 illustrates that the system message 801 that is not abbreviated is displayed on the chat interface 802 of the chat conversation between the first user account (David) and the second user account (Peter).

For the second way, there is a problem that the long system message cannot be entirely displayed within the preview region of the chat conversation corresponding to the user in the chat conversation list. In view of this, a method for abbreviating the system message is provided in the disclosure. In detail, abbreviating the system message includes obtaining processed system message by removing the abbreviated message identification; and in response to a length of the processed system message being greater than a length of a preview region of a target chat conversation, displaying a part of the processed system message beyond the preview region as a preset symbol.

For ease of understanding, the process of abbreviating the system message will be described in detail in combination with FIG. 7. In FIG. 7, the content displayed within the preview region of the chat conversation corresponding to “Real estate agency Chen” 705 should normally be “Real estate agency Chen responds to your message (smiley face emoji)”. After removing the abbreviated message identification, the content displayed within the preview region should be “Real estate agent Chen responds to you (smiley face emoji)”. Since the length of the processed system message is still longer than the length of the preview region 705 of the target chat conversation, the processed system message cannot be fully displayed, and only “Real estate agent Chen responds” is displayed. Therefore, the part of the system message beyond the preview region 705 of the target chat conversation is displayed as a preset symbol 708. For example, the preset symbol can be an ellipsis (...), a wavy line, or the like, which is not an exhaustive list.

In addition, it is possible that multiple user accounts continuously perform the emoji-expressive reply operation on the same conversation message on the chat interface. If there are too many users who performed the emoji-expressive reply operation on the conversation message, the content of the chat page will be mixed and disorderly and the user experience will be poor. In view of this, the following solutions are provided in the disclosure.

In embodiments of the disclosure, obtaining the system message corresponding to the emoji-expressive reply operation in response to receiving the emoji-expressive reply operation performed by the first user account on the conversation message sent by the second user account includes: in response to the number of different first user accounts who performed the emoji-expressive reply operations on the conversation message not being greater than a number threshold, obtaining first system messages respectively corresponding to the first user accounts. Each first system message includes a user identification of a corresponding first user account, an abbreviated message identification, and corresponding attitude information.

Displaying the system message on the chat interface of the chat conversation including the second user account includes: displaying the first system messages corresponding to the first user accounts respectively on the chat interface of the chat conversation including the second user account.

The number threshold may be 3, 4, 5, or 6.

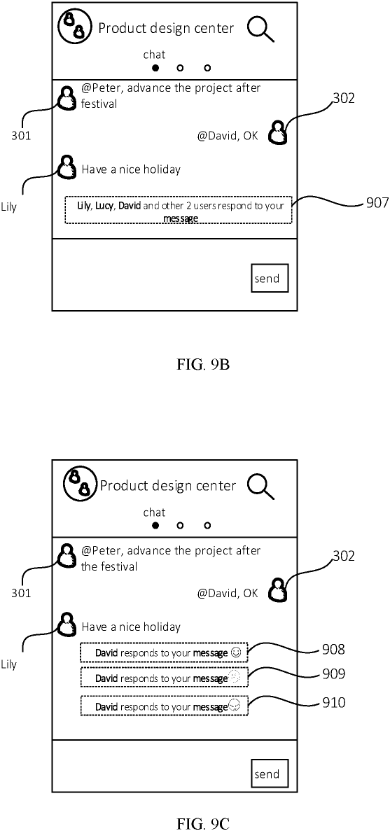

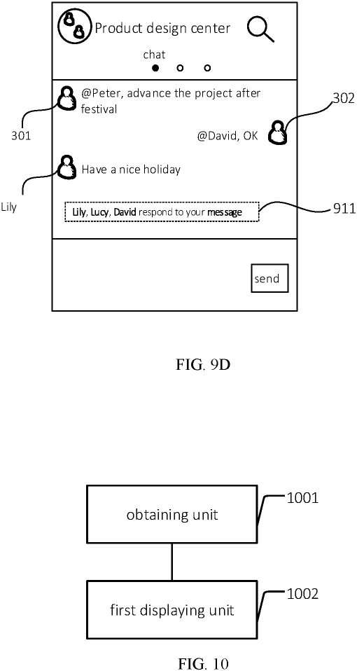

For ease of understanding, the above situation will be illustrated below in combination with FIG. 9A. Assuming that the number threshold is 3. In FIG. 9A, there are 3 first user accounts (namely David, Lily and Lucy) perform the emoji-expressive reply operation on the conversation message, and on the chat interface 903 of the second user account, the first system message 904 corresponding to David is “David responds to your message (smiley face emoji)”, the first system message 905 corresponding to Lily is “Lily responds to your message (smiley face emoji)”, and the first system message 906 corresponding to Lucy is “Lucy responds to your message (smiley face emoji)”. It is understandable that as long as the number of the first user accounts is less than the number threshold, the first system messages (904, 905, 906) corresponding to these first user accounts are displayed respectively on the chat interface of the second user account. It is to be noted that, in this process, the emoji-expressive reply operations performed on the conversation message may be the same or different.

In embodiments of the disclosure, after the first system messages corresponding to different first user accounts are displayed respectively on the chat interface of the chat conversation including the second user account, the method further includes in response to the emoji-expressive reply operations performed by multiple different third user accounts in turn on the conversation message, obtaining a second system message. The second system message includes the total number of the different third user accounts, the user identifications of the first user accounts and the abbreviated message identification. The term “in turn” means that the multiple different third user accounts continuously perform the emoji-expressive reply operations on the same conversation message and there is no any other conversation message or system message during this process.

The second system message is displayed on the chat interface of the chat conversation including the second user account. At this time, the first system messages can be retained or deleted.

For ease of understanding, the above situation will be described in combination with FIG. 9B. Assuming that the number threshold is 3. In FIG. 9B, there are 5 user accounts, including 3 different first user accounts (Lily, Lucy, David) and 2 different third user accounts (Amy, Andy). These 5 user accounts perform the emoji-expressive reply operation in turn on the conversation message, such that the second system message 907 is “Lily, Lucy, David and other 2 users respond to your message.”

As another implementation, the second system message 907 may include the total number of the first user accounts and the different third user accounts, the respective user identifications of the first user accounts and the abbreviated message identification. Therefore, for the above example, the second system message 907 is “5 users including Lily, Lucy, David respond to your message.”

It is understandable that if the same user account continuously performs the emoji-expressive reply operation many times on the same conversation message, the first system messages are displayed. As illustrated in FIG. 9C, David responds to the same conversation message “OK” three times, and 3 first system messages 908, 909, 910 are displayed on the chat interface 903. It is to be noted that, once the same user account continuously performs the emoji-expressive reply operation many times on the same conversation message, when other different third user accounts perform the emoji-expressive reply operation in turn on the same conversation message, the emoji-expressive reply operations performed by the same user account and the emoji-expressive reply operations performed by the different third user accounts on the same conversation message may be aggregated into a second system message, and the second system message is displayed on the chat interface 903 of the second user account.

After the second system message is displayed on the chat interface of the chat conversation including the second user account, the user account may initiate to withdraw the emoji-expressive reply operation of the conversation message. In view of this, the method according to the disclosure further includes: receiving a response withdrawing operation performed by a target user account on the emoji-expressive reply operation of the conversation message; in response to the target user account being one of different first user accounts, deleting the user identification of the target user account from the second system message; and in response to the target user account being one of the plurality of third user accounts, updating the total number in the second system message.

For ease of understanding, the above situation will be described below in combination with FIG. 9B and FIG. 9D. In FIG. 9B, the second system message 907 is “Lily, Lucy, David and other 2 users respond to your message”, where “Lily, Lucy, David” are the first user accounts, and the 2 users other than Lily, Lucy, and David are the third user accounts. In this case, if it is determined that the target user account is Lily, the user identification of the target user account is deleted from the second system message 907. That is, the second system message 907 becomes “Lucy, David and other 2 users respond to your message”. If it is determined that the target user account is one of the 2 users other than Lily, Lucy, and David, the total number of accounts in the second system message 907 is updated. That is, the second system message 907 becomes “Lily, Lucy, David and other 1 user respond to your message” 911.

In the specific implementation, in response to determining that the number of user accounts in the second system message 907 after performing the response withdrawing operation is reduced to equal to or less than the number threshold, for example the number threshold is 3 and when the emoji-expressive reply operations corresponding to Lily, Lucy and David are left after the response withdrawing operation performed on the emoji-expressive reply operations, the second system message 907 becomes “Lily, Lucy, David respond to your message”, as illustrated in FIG. 9D for details. However, if only the emoji-expressive reply operation corresponding to Lily is left after the response withdrawing operation performed on the emoji-expressive reply operations of the 5 users, in order to avoid causing confusion, the second system message 907 becomes the form of the first system message, that is, “Lily responds to your message (smiley face emoji).”

FIG. 10 is a schematic diagram illustrating an apparatus for displaying a message according to an embodiment. As illustrated in FIG. 10, the apparatus includes an obtaining unit 1001 and a first displaying unit 1002.

The obtaining unit 1001 is configured to obtain a system message corresponding to an emoji-expressive reply operation performed by a first user account on a conversation message sent by a second user account, in response to receiving the emoji-expressive reply operation. The system message includes a user identification of the first user account, an abbreviated message identification and attitude information corresponding to the emoji-expressive reply operation.

The first displaying unit 1002 is configured to display the system message on a chat interface of the second user account.

In an example, the first displaying unit 1002 is further configured to display the system message at the top or bottom of a visible region of the chat interface of a chat conversation including the second user account; or display the system message within a preset region of the chat interface of the chat conversation including the second user account. The preset region is determined by a position of the message input box and a position of the last conversation message on the chat interface.

In an example, the apparatus further includes a jumping unit.

The jumping unit is configured to jump to a position where the conversation message is displayed in response to a viewing operation performed by the second user account on the abbreviation message identification.

In an example, the apparatus further includes a second displaying unit.

The second displaying unit is configured to display profile information of the first user account in response to a viewing operation performed by the second user account on the user identification.

In an example, the first displaying unit 1002 is further configured to display the system message on the chat interface in response to the chat interface being in an open state.

In an example, the first displaying unit 1002 is further configured to obtained abbreviated system message by abbreviating the system message in response to the chat interface being in a closed state; displaying the abbreviated system message within a preview region of a target chat conversation corresponding to the first user account in the chat conversation list. The target chat conversation is a chat conversation between the second user account and the first user account. The first displaying unit 102 is further configured to display the system message that is not abbreviated on the chat interface in response to a viewing operation performed by the second user account on the preview region of the target chat conversation.

In an example, the first displaying unit 1002 is further configured to obtain a processed system message by removing the abbreviated message identification; and display a part of the processed system message beyond the preview region as a preset symbol in response to a length of the processed system message being greater than a length of the preview region of the target chat conversation.

In an example, the obtaining unit 1001 is further configured to in response to the number of different first user accounts who perform the emoji-expressive reply operations on the conversation message not exceed a number threshold, obtain the first system messages respectively corresponding to the first user accounts. The first system message includes: user identifications corresponding to the first user accounts, an abbreviated message identification and corresponding attibute information. The first displaying unit is further configured to display the first system messages corresponding to the first user accounts respectively on the chat interface of the chat conversation including the second user account.

In an example, the apparatus further includes a responding unit and a third displaying unit.

The responding unit is configured to obtain a second system information in response to emoji-expressive reply operations performed by a plurality of different third user accounts on the conversation message. The second system message includes the total number of the plurality of different third user accounts, the user identifications of the first user accounts, and the abbreviated message identification.

The third displaying unit is configured to display the second system message on the chat interface of the chat conversation including the second user account.

In an example, the apparatus further includes a receiving unit, a second deleting unit, and an updating unit.

The receiving unit is configured to receive response withdrawing operation performed by a target user account on the emoji-expressive reply operation of the conversation message.

The second deleting unit is configured to delete the user identification of the target user account from the second system message in response to the target user account being one of the different first user accounts.

The updating unit is configured to update the total number of accounts in the second system message in response to the target user account being one of the plurality of third user accounts.

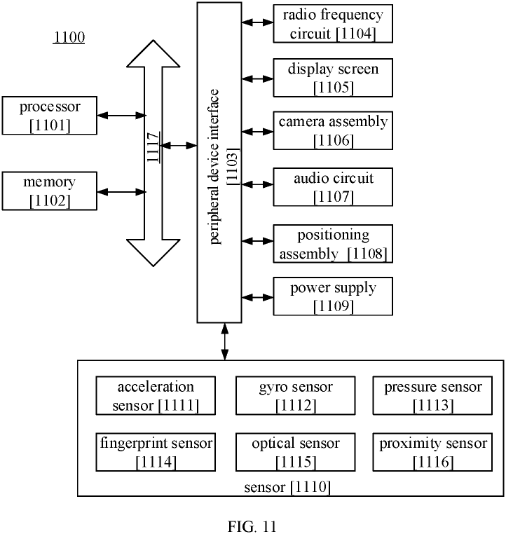

FIG. 11 is a block diagram illustrating an electronic device according to an embodiment. The electronic device 1100 may be an electronic device used by a user. The electronic device 1100 may be a smartphone, a smart watch, a desktop computer, a laptop computer, and a laptop electronic device, a desktop electronic device, or the like.

Generally, the electronic device 1100 includes a processor 1101 and a memory 1102.

The processor 1101 may include one or more processing cores, such as a 4-core processor, an 8-core processor, and the like. The processor 1101 may adopt at least one hardware form among DSP (Digital Signal Processing), FPGA (Field-Programmable Gate Array), PLA (Programmable Logic Array). The processor 1101 may also include a main processor and a coprocessor. The main processor is a processor used to process data in the wake-up state, also called a CPU (Central Processing Unit). The coprocessor is a low power-consumption processor configured to process data in a standby state. In some embodiments, the processor 1101 may be integrated with a GPU (Graphics Processing Unit, image processor), and the GPU is configured to render and draw the content to be displayed on the display screen. In some embodiments, the processor 1101 may further include an AI (Artificial Intelligence) processor configured to process computing operations related to machine learning.

The memory 1102 may include one or more storage media, which may be non-transitory. The memory 1102 may also include high-speed random access memory, as well as non-volatile memory, such as one or more disk storage devices, flash storage devices.

In some embodiments, the electronic device 1100 may also include: a peripheral device interface 1103 and at least one peripheral device. The processor 1101, the memory 1102 and the peripheral device interface 1103 may be connected through a bus or a signal line 1117. Each peripheral device can be connected to the peripheral device interface 1103 through a bus, a signal line or a circuit board. The peripheral device includes at least one of a radio frequency circuit 1104, a display screen 1105, a camera assembly 1106, an audio circuit 1107, a positioning assembly 1108 and a power supply 1109.

The peripheral device interface 1103 is configured to connect at least one peripheral device related to I/O (Input/Output) to the processor 1101 and the memory 1102. In some embodiments, the processor 1101, the memory 1102, and the peripheral device interface 1103 are integrated on the same chip or circuit board. In some embodiments, any one or two of the processor 1101, the memory 1102, and the peripheral device interface 1103 are integrated on a separate chip or circuit board, which is not limited in the disclosure.

The radio frequency circuit 1104 is configured to receive and transmit RF (Radio Frequency) signals, also called electromagnetic signals. The radio frequency circuit 1104 communicates with communication networks and other communication devices via electromagnetic signals. The radio frequency circuit 1104 converts electrical signals into electromagnetic signals for transmission, or converts received electromagnetic signals into electrical signals. Alternatively, the radio frequency circuit 1104 includes an antenna system, an RF transceiver, one or more amplifiers, tuners, oscillators, digital signal processors, codec chipsets, subscriber identity module cards, and the like. The radio frequency circuit 1104 may communicate with other terminals through at least one wireless communication protocol. The wireless communication protocols include, but are not limited to, metropolitan area networks, mobile communication networks of various generations (2G, 3G, 4G and 5G), wireless local area networks and/or WiFi (Wireless Fidelity). In some embodiments, the radio frequency circuit 1104 may further include a circuit related to NFC (Near Field Communication), which is not limited in the disclosure.

The display screen 1105 is configured to display a UI (User Interface). The UI can include images, text, icons, video, and any combination thereof. When the display screen 1105 is a touch display screen, the display screen 1105 also has an ability of acquiring touch signals on or above the surface of the display screen 1105. The touch signal can be input to the processor 1101 as a control signal. At this time, the display screen 1105 may be used to provide virtual buttons and/or virtual keyboards, also referred to as soft buttons and/or soft keyboards. In some embodiments, there may be one display screen 1105, which is on the front panel of the electronic device 1100. In some embodiments, there may be at least two display screens 1105, which are respectively on different surfaces of the electronic device 1100 or in a folded design. In some embodiments, the display screen 1105 may be a flexible display screen on a curved surface or a folding surface of the electronic device 1100. The display screen 1105 can have a non-rectangular and irregular shape, that is, a special-shaped screen. The display screen 1105 can be made of materials such as LCD (Liquid Crystal Display), OLED (Organic Light-Emitting Diode), or the like.

The camera assembly 1106 is configured to capture images or record videos. Alternatively, the camera assembly 1106 includes a front camera and a rear camera. The front camera is on the front panel of the electronic device, and the rear camera is on the back surface of the electronic device. In some embodiments, there are at least two rear cameras. Each rear camera is any one of a main camera, a depth-of-field camera, a wide-angle camera, and a telephoto camera, such that the main camera and the depth-of-field camera can work together to realize the background blur function, the main camera and the wide-angle camera can work together to realize panoramic shooting and VR (Virtual Reality) shooting functions or other shooting functions. In some embodiments, the camera assembly 1106 may include a flash. The flash can be a single color temperature flash or a dual color temperature flash. Dual color temperature flash refers to the combination of warm light flash and cold light flash, which can be configured for light compensation under different color temperatures.

The audio circuit 1107 may include a microphone and a speaker. The microphone is configured to collect sound waves of the user and the environment, convert the sound waves into electrical signals, and input the electrical signals to the processor 1101 for processing, or input the electrical signals to the radio frequency circuit 1104 to realize sound communication. For the purpose of stereo acquisition or noise reduction, there may be multiple microphones, which are respectively disposed in different parts of the electronic device 1100. The microphone may be array microphones or an omnidirectional collection microphone. The speaker is configured to convert the electrical signal from the processor 1101 or the radio frequency circuit 1104 into sound waves. The speaker can be a traditional thin-film speaker or a piezoelectric ceramic speaker. When the speaker is the piezoelectric ceramic speaker, the speaker can not only convert electrical signals into sound waves audible to humans, but also convert electrical signals into sound waves inaudible to humans for ranging and other purposes. In some embodiments, the audio circuit 1107 may include a headphone jack.

The positioning assembly 1108 is configured to position the current geographic location of the electronic device 1100 to implement navigation or LBS (Location Based Service). The positioning assembly 1108 may be a positioning component based on the GPS (Global Positioning System) of the United States, the Beidou system of China, the Grenas system of Russia, or the Galileo system of the European Union.

The power supply 1109 is configured to power various components in the electronic device 1100. The power supply 1109 may be alternating current, direct current, disposable, or rechargeable batteries. When the power supply 1109 includes a rechargeable battery, the rechargeable battery can support wired charging or wireless charging. The rechargeable battery can support fast charging technology.

In some embodiments, the electronic device 1100 also includes one or more sensors 1110. The one or more sensors 1110 include, but are not limited to, an acceleration sensor 1111, a gyro sensor 1112, a pressure sensor 1113, a fingerprint sensor 1114, an optical sensor 1115 and a proximity sensor 1116.

The acceleration sensor 1111 can detect the acceleration on the three coordinate axes of the coordinate system established by the electronic device 1100. For example, the acceleration sensor 1111 can be configured to detect the components of the gravitational acceleration on the three coordinate axes. The processor 1101 can control the display screen 1105 to display the user interface in a landscape view or a portrait view according to the gravitational acceleration signal collected by the acceleration sensor 1111. The acceleration sensor 1111 can be configured to collect data of a game or user movement.

The gyroscope sensor 1112 can detect the body direction and rotation angle of the electronic device 1100, and the gyroscope sensor 1112 can cooperate with the acceleration sensor 1111 to collect the 3D actions of the electronic device 1100 under the control of the user. The processor 1101 can implement the following functions according to the data collected by the gyroscope sensor 1112: motion sensing (such as changing the UI according to the user’s tilt operation), image stabilization during shooting, game control, and inertial navigation.

The pressure sensor 1113 may be on the side frame of the electronic device 1100 and/or at the lower layer of the display screen 1105. When the pressure sensor 1113 is disposed on the side frame of the electronic device 1100, the holding signal that the user holds the electronic device 1100 can be detected, and the processor 1101 can recognize whether the left or the right hand holds the electronic device 1100 or recognize quick operation according to the holding signal collected by the pressure sensor 1113. When the pressure sensor 1113 is disposed at the lower layer of the display screen 1105, the processor 1101 controls the operable controls on the UI interface according to the user’s pressure operation on the display screen 1105. The operable controls include at least one of button control, slide bar control, icon control, and menu control.

The fingerprint sensor 1114 is configured to collect the user’s fingerprint, and the processor 1101 identifies the user identity according to the fingerprint collected by the fingerprint sensor 1114, or the fingerprint sensor 1114 identifies the user identity according to the collected fingerprint. When the user identity is identified as a trusted identity, the processor 1101 authorizes the user to perform related sensitive operations, including unlocking the screen, viewing encrypted information, downloading software, making payments, and changing settings. The fingerprint sensor 1114 may be on the front, back, or side surface of the electronic device 1100. When the electronic device 1100 is provided with physical buttons or a manufacturer’s logo, the fingerprint sensor 1114 can be integrated with the physical buttons or the manufacturer’s logo.

The optical sensor 1115 is configured to collect ambient light intensity. In an example, the processor 1101 can control the display brightness of the display screen 1105 according to the ambient light intensity collected by the optical sensor 1115. When the ambient light intensity is relatively high, the display brightness of the display screen 1105 is increased. When the ambient light intensity is relatively low, the display brightness of the display screen 1105 is decreased. In another example, the processor 1101 can dynamically adjust the shooting parameters of the camera assembly 1106 according to the ambient light intensity collected by the optical sensor 1115.

The proximity sensor 1116, also referred to as a distance sensor, is typically arranged on the front panel of electronic device 1100. The proximity sensor 1116 is configured to collect the distance between the user and the front surface of the electronic device 1100. In an example, when the proximity sensor 1116 detects that the distance between the user and the front surface of the electronic device 1100 gradually decreases, the processor 1101 controls the display screen 1105 to switch from the screen-on state to the screen-off state. When the proximity sensor 1116 detects that the distance between the user and the front surface of the electronic device 1100 gradually increases, the processor 1101 controls the display screen 1105 to switch from the screen-off state to the screen-on state.

Those skilled in the art can understand that the structure illustrated in FIG. 5 does not constitute a limitation on the electronic device 1100, and may include more or less components than those shown, or those components can be combined, or different component arrangements can be adopted.

In an example, the disclosure also provides a computer-readable storage medium including instructions, such as a memory including instructions. The instructions can be executed by the processor 1101 of the electronic device 1100 to execute the above-mentioned method for displaying a message. Alternatively, the storage medium may be a non-transitory storage medium. The non-transitory storage medium may be a ROM, a random access memory (RAM), a CD-ROM, a magnetic tape, a floppy disk, an optical data storage device, and the like.

In an example, the disclosure also provides a computer program product, including a computer program, which can be executed by a processor of an electronic device to implement the above-mentioned method for displaying a message.

Other embodiments of the disclosure will readily occur to those skilled in the art upon consideration of the specification and practice of the disclosure described herein. This disclosure is intended to cover any variations, uses, or adaptations of this disclosure that follow the general principles of this disclosure and include common general knowledge or techniques in the technical field that are not disclosed by this disclosure. The specification and examples are to be regarded as exemplary only, with the true scope and spirit of the disclosure being indicated by the following claims.

It is to be understood that the disclosure is not limited to the precise structures described above and illustrated in the accompanying drawings, and that various modifications and changes may be made without departing from the scope thereof. The scope of the disclosure is limited only by the appended claims.

What is claimed is:

1. A method for displaying a message, comprising:
in response to receiving an emoji-expressive reply operation performed by a first user account on a conversation message sent by a second user account, obtaining a system message corresponding to the emoji-expressive reply operation; wherein the system message comprises a user identification of the first user account, an abbreviated message identification, and attitude information corresponding to the emoji-expressive reply operation; and
displaying the system message on a chat interface of a chat conversation including the second user account.

2. The method of claim 1, wherein said displaying the system message on the chat interface of the chat conversation including the second user account comprises:
displaying the system message at the top or bottom of a visible region of the chat interface of the chat conversation including the second user account; or
displaying the system message within a preset region of the chat interface of the chat conversation including the second user account, wherein the preset region is determined based on a position of a message input box and a position of a last conversation message on the chat interface.

3. The method of claim 1, further comprising:
jumping to a position where the conversation message is displayed, in response to a viewing operation performed by the second user account on the abbreviated message identification.

4. The method of claim 1, further comprising:
displaying profile information of the first user account, in response to a viewing operation performed by the second user account on the user identification.

5. The method of claim 1, wherein said displaying the system message on the chat interface of the chat conversation including the second user account comprises:
in response to the chat interface being in an open state, displaying the system message on the chat interface.

6. The method of claim 1, wherein said displaying the system message on the chat interface of the chat conversation including the second user account comprises:
obtaining an abbreviated system message by abbreviating the system message in response to the chat interface being in a closed state;
displaying the abbreviated system message within a preview region of a target chat conversation corresponding to the first user account in a chat conversation list, wherein the target chat conversation is a chat conversation of the second user account; and
displaying the chat interface in response to a viewing operation performed by the second user account on the preview region, and displaying the system message that is not abbreviated on the chat interface.

7. The method of claim 6, wherein said abbreviating the system message comprises:
obtaining a processed system message by removing the abbreviated message identification; and
in response to a length of processed system message being greater than a length of the preview region of the target chat conversation, displaying a part of the processed system message beyond the preview region as a preset symbol.

8. The method of claim 1, wherein said obtaining the system message corresponding to the emoji-expressive reply operation in response to receiving the emoji-expressive reply operation performed by the first user account on the conversation message sent from the second user account comprises:
obtaining first system messages respectively corresponding to the first user accounts, in response to the number of first user accounts performing the emoji-expressive reply operations on the conversation message not being greater than a number threshold, wherein each first system message comprises a user identification of the first user account, an abbreviated message identification and corresponding attitude information; and
wherein said displaying the system information on the chat interface of the chat conversation including the second user account comprises:
displaying the first system messages corresponding to the first user accounts respectively on the chat interface of the chat conversation including the second user account.

9. The method of claim 8, further comprising:
obtaining a second system message, in response to emoji-expressive reply operations performed by a plurality of different third user accounts on the conversation message, wherein the second system message comprises the total number of different third user accounts, user identifications of the first user accounts, and the abbreviated message identification; and
displaying the second system message on the chat interface of the chat conversation including the second user account.

10. The method of claim 9, further comprising:
receiving a response withdrawing operation performed by a target user account on the emoji-expressive reply operation of the conversation message;
deleting the user identification of the target user account from the second system message in response to the target user account being one of the different first user accounts; or
updating the total number in the second system message in response to the target user account being one of the third user accounts.

11. An electronic device, comprising:
a processor; and
a memory, storing instructions executable by the processor;
wherein when the instructions are executed by the processor, the processor is configured to:
in response to receiving an emoji-expressive reply operation performed by a first user account on a conversation message sent by a second user account, obtain a system message corresponding to the emoji-expressive reply operation; wherein the system message comprises a user identification of the first user account, an abbreviated message identification, and attitude information corresponding to the emoji-expressive reply operation; and
display the system message on a chat interface of a chat conversation including the second user account.

12. The electronic device of claim 11, wherein the processor is further configured to:
display the system message at the top or bottom of a visible region of the chat interface of the chat conversation including the second user account; or
display the system message within a preset region of the chat interface of the chat conversation including the second user account, wherein the preset region is determined based on a position of a message input box and a position of a last conversation message on the chat interface.

13. The electronic device of claim 11, wherein the processor is further configured to:
jump to a position where the conversation message is displayed, in response to a viewing operation performed by the second user account on the abbreviated message identification; or
display profile information of the first user account, in response to a viewing operation performed by the second user account on the user identification.

14. The electronic device of claim 11, wherein the processor is further configured to:
in response to the chat interface being in an open state, display the system message on the chat interface.

15. The electronic device of claim 11, wherein the processor is further configured to:
obtain an abbreviated system message by abbreviating the system message in response to the chat interface being in a closed state;
display the abbreivated system message within a preview region of a target chat conversation corresponding to the first user account in a chat conversation list, wherein the target chat conversation is a chat conversation of the second user account; and
display the chat interface in response to a viewing operation performed by the second user account on the preview region, and displaying the system message that is not abbreviated on the chat interface.

16. The electronic device of claim 15, wherein the processor is further configured to:
obtain a processed system message by removing the abbreviated message identification; and
in response to a length of processed system message being greater than a length of the preview region of the target chat conversation, display a part of the processed system message beyond the preview region as a preset symbol.

17. The electronic device of claim 11, wherein the processor is further configured to:
obtain first system messages respectively corresponding to the first user accounts, in response to the number of first user accounts performing the emoji-expressive reply operations on the conversation message not being greater than a number threshold, wherein each first system message comprises a user identification of the first user account, an abbreviated message identification and corresponding attitude information; and
display the first system messages corresponding to the first user accounts respectively on the chat interface of the chat conversation including the second user account.

18. The electronic device of claim 17, wherein the processor is further configured to:
obtain a second system message, in response to emoji-expressive reply operations performed by a plurality of different third user accounts on the conversation message, wherein the second system message comprises the total number of different third user accounts, user identifications of the first user accounts, and the abbreviated message identification; and
display the second system messgae on the chat interface of the chat conversation including the second user account.

19. The electronic device of claim 18, wherein the processor is further configured to:
receive a response withdrawing operation performed by a target user account on the emoji-expressive reply operation of the conversation message;
delete the user identification of the target user account from the second system message in response to the target user account being one of the different first user accounts; or
update the total number in the second system message in response to the target user account being one of the third user accounts.

20. A non-transitory computer readable storage medium, wherein when instructions stored in the computer readable storage medium are executed by a processor of an electronic device, the electronic device is caused to implement the method for displaying a message, the method comprising:
in response to receiving an emoji-expressive reply operation performed by a first user account on a conversation message sent by a second user account, obtaining a system message corresponding to the emoji-expressive reply operation; wherein the system message comprises a user identification of the first user account, an abbreviated message identification, and attitude information corresponding to the emoji-expressive reply operation; and
displaying the system message on a chat interface of a chat conversation including the second user account.
